(19) United States
(12) Patent Application Publication
(10) Pub. No.: US 2008/0306851 A1
(43) Pub. Date: Dec. 11, 2008

(54) METHOD AND SYSTEM FOR MANAGING ACCOUNTS USING A SOCIAL NETWORK OVER A NETWORK

(76) Inventor: Jason Weyerman, Omaha, NE (US)

Correspondence Address: HUSCH BLACKWELL SANDERS LLP, 1620 DODGE STREET, SUITE 2100, OMAHA, NE, 68102, US

(21) Appl. No.: 12/109,821

(22) Filed: Apr. 25, 2008

Related U.S. Application Data
(60) Provisional application No. 60/914,260, filed on Apr. 26, 2007.

(51) Int. Cl. G06Q 40/00

(52) U.S. Cl. 705/35

(57) ABSTRACT

The present invention generally relates to data processing, and more particularly, to a method and system for managing accounts using online social network. The method and system allow for computer implemented management of a trust and other accounts4 over a network where the network users can generate and share content including journals, videos, and audio files.

### CROSS-REFERENCE TO RELATED APPLICATION

This application claims the benefit of and priority to U.S. Provisional Patent Application No. 60/914,260, filed Apr. 26, 2007, entitled METHOD AND SYSTEM FOR MANAGING TRUST ACCOUNTS USING SOCIAL NETWORKS OVER A NETWORK, which document is hereby incorporated by reference to the extent permitted by law.

### BACKGROUND OF THE INVENTION

The present invention generally relates to data processing, and more particularly, to a method and system for managing accounts using an online social network.

Parents have tried to be the best parents they can as they work at the hardest job in the world: raising kids. One financial way to support their children is by setting up a child trust fund or other financial account. Many parents and grandparents have set up trust funds for their children and grandchildren. Today, with ordinary people becoming millionaires through the increased property value of their homes and stock market-driven accumulations in their company retirement plans, trust funds are becoming more commonplace. Parents and grandparents in this category are undertaking estate planning to preserve their wealth and minimize estate taxes.

Grandparents or other family members may be especially interested in making gifts to their grandchildren or children. Sometimes, they want to make gifts to the children to celebrate a birthday or graduation. Grandparents can do this while they are alive. Parents, grandparents, godparents and other family friends can all contribute to the same ‘pot’ and this will also make saving easier so people will be more likely to do it.

One example of a financial account that may be used for these purposes is a trust fund. The property in the trust is managed by a trustee. However, usually parents or children do not have enough financial knowledge for investment of the trust fund. Many affluent families today are seeking ways to teach their children about the responsibilities that come with wealth and how to effectively manage their finances. One way to foster financial literacy in parents and children is through advice from their family members and friends. They can encourage responsible financial decision-making in children through their advice.

However, today's work and home lifestyles can be very busy for many families. In many cases, individual family members, grandparents and their friends may be involved in multiple activities. Oftentimes, individual family members and friends may have very little personal interaction. Thus, it is difficult to get necessary advice at the right time from the right person due to a lot of reasons. It is also difficult to collect and store the advice provided by parents, grandparents, godparents and other family friends. Manual processes to gather and collect advice for financial decision-making are both time consuming and error prone.

Further, it is difficult to encourage or induce family members and friends to make gifts (in trust or otherwise) because they may need some motivation for making the gifts.

It is evident from the above discussion that an ongoing need exists for improved ways to set up the account.

### BRIEF SUMMARY OF THE INVENTION

The present invention solves the above and other problems, thereby advancing the state of the useful arts, by providing methods and associated structures for enabling an effective way of managing financial accounts.

It is an aspect of the present invention to provide a method of managing financial accounts over a network, which allows an account manager to manage a financial account for at least one account holder over a network. The method provides a user interface in association with the account manager, wherein the account information is displayed via the user interface. The method allows family member or friends to journal their personal and public messages to the financial account, account holder, or account holder as they help build the financial future of the account holder. At least one user authorized by the account manager or other authorized user can send data using the user interface. The data received from the user is stored in a database and displayed using the user interface. At least some of the data can be accessed only by at least one selected from the group consisting of the authorized user, the account manager, a donor and the account holder.

It is another aspect of the present invention to provide a method of managing financial accounts over a network, which allows an account manager to open an account for at least one account holder over a network. The method provides a user interface in association with the account manager, wherein the account information is displayed via the user interface. If at least one user authorized by the account manager requests to transfer funds to the account holder's account using the user interface, requested data for the fund transfer is transmitted to the financial account. Further, the financial account balance information including the fund transfer is displayed using the user interface, wherein at least some of the financial account balance information can be accessed only by at least one selected from the group consisting of the authorized user, the account manager, the donor and the account holder.

### BRIEF DESCRIPTION OF THE SEVERAL VIEWS OF THE DRAWINGS

The above and/or other aspects and advantages of the present invention will become apparent and more readily appreciated from the following detailed description, taken in conjunction with the accompanying drawings of which:

FIG. 1 illustrates the general architecture of a system for managing a trust fund account in accordance with one embodiment of the present invention;

FIG. 2 illustrates page flow diagram showing how the system allows the user to deposit money at the trust find account and to post journals, pictures, videos, and other information relevant to the trust fund account according to an exemplary embodiment of the present invention;

FIG. 3 is an exemplary graphical user interface of the family's area according to an exemplary embodiment of the present invention;

FIG. 4 is an exemplary graphical user interface of the beneficiary's public area according to an exemplary embodiment of the present invention;

FIG. 5 is an exemplary graphical user interface of the beneficiary's private area according to an exemplary embodiment of the present invention;

FIG. 6 is an exemplary graphical user interface of the beneficiary's private journal area according to an exemplary embodiment of the present invention;

FIG. 7 is an exemplary graphical user interface for the beneficiary's public journal area according to an exemplary embodiment of the present invention;

FIG. 8 is an exemplary graphical user interface for online banking according to an exemplary embodiment of the present invention;

FIG. 9 is an exemplary graphical user interface that may be displayed in embodiments of the present invention;

FIG. 10 illustrates an exemplary graphical user interface of the master account area according to an exemplary embodiment of the present invention;

### DETAILED DESCRIPTION OF THE INVENTION

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a module. One or more components can reside within a process and/or thread of execution, and a module or component can be localized on one computer and/or distributed between two or more computers.

As used herein, the terms “desktop,” “PC,” “local computer,” and the like, refer to computers on which systems (and methods) according to the invention operate. In the illustrated embodiments, these are personal computers, such as portable computers and desktop computers; however, in other embodiments, they may be other types of computing devices (e.g., workstations, mainframes, personal digital assistants or PDAs, music or MP3 players, and the like).

### DEFINITIONS

Account holder—a person for whose benefit a financial account is maintained though not necessarily the legal title holder (e.g. the beneficiary of a trust account).

Account manager—a person who manages the account for the benefit of another (e.g. the trustee of a trust account).

Beneficiary—A person who is designated to benefit from a trust.

Trust—A fiduciary relationship regarding property and subjecting the person with title to the property to equitable duties to deal with it for another's benefit.

Trust fund—The property held in a trust by a trustee.

Trustee—One who, having legal title to property, holds it in trust for the benefit of another and owes a fiduciary duty to that beneficiary.

Trustor—One who creates a trust.

While a trust account provides a useful example for how the system may be employed, other accounts may be used. For example, college and other savings accounts, retirement and other investment accounts, charitable accounts, and other financial accounts may all be used with the disclosed system.

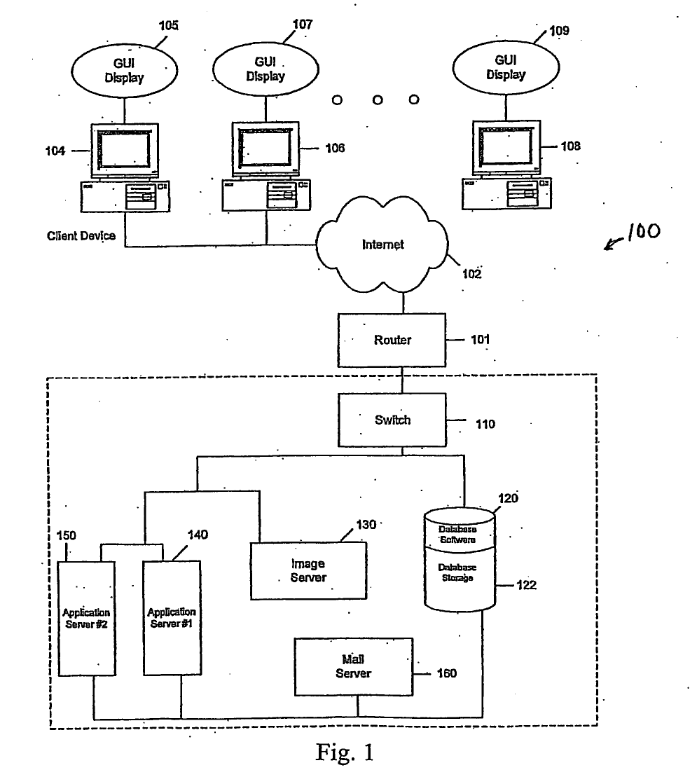

FIG. 1 illustrates the general architecture of a system that operates in accordance with one embodiment of the present invention. As shown in FIG. 1, a plurality of graphical user interface (GUI) displays 105, 107, 109 are presented on a plurality of user interface devices 104, 106, 108 connected to a system 100 via the Internet 102. The user interface may be any device capable of presenting data, including, but not limited to, cellular telephones, television sets or hand-held “personal digital assistants.” As used herein, the term “Internet” generally refers to any collection of distinct networks working together to appear as a single network to a user. The term refers to the so-called world wide “network of networks” that are connected to each other using the Internet protocol (IP) and other similar protocols. The Internet provides file transfer, remote log in, electronic mail, news and other services. As described herein, the exemplary public network of FIG. 1 is for descriptive purposes only. Although the description may refer to terms commonly used in describing particular public networks such as the Internet, the description and concepts equally apply to other public and private computer networks, including systems having architectures dissimilar to that shown in FIG. 1. For example, and without limitation thereto, the system of the present invention can find application in public as well as private networks, such as a closed university social system, or the private network of a company.

The system 100 is connected to the Internet 102 through a router 101 and a switch 110. As is well known in the relevant art(s), routers forward packets between networks. The router 101 forwards information packets between the system 100 and devices 104, 106, 108 over the Internet 102. The switch 110 may act as a gatekeeper to and from the Internet 102. The components appearing in the system 100 refer to an exemplary combination of those components that would need to be assembled to create the infrastructure in order to provide the tools and services contemplated by the present invention. As will be apparent to one skilled in the relevant art(s), all of the components “inside” of the system 100 may be connected and may communicate via a wide or local area network (WAN or LAN).

The system 100 includes an application server 140 or a plurality of application servers 140, 150. Yet another server is the image server 130, which has the purpose of storing and providing digital images to other components of the system 100. Also included is a mail server 160, which sends and receives electronic messages to and from devices 104, 106, 108. Also included are the database software 120 and a database 122.

The system 100 sends out Web pages in response to Hypertext Transfer Protocol (HTTP) requests from remote browsers (i.e. users of the system 100). That is, the system 100 provides the GUI 105, 107, 109 to users of the system in the form of Web pages. These Web pages sent to the user's device 104, 106, 108 would result in GUI screens 105, 107, 109 being displayed.

The system 100 also includes a second switch, not shown, that allows the components of the system to be interconnected in a local area network (LAN) or a wide area network (WAN). Thus, data can be transferred to and from the various components of the system 100.

As will be appreciated by those skilled in the relevant art(s), this configuration of a router 101 and switch 110 is flexible and can be omitted in certain embodiments. Additional routers and/or switches can also be added.

The application server 140 may include a central processing unit (CPU), a random access memory (RAM) for temporary storage of information, and a read only memory (ROM) for permanent storage of information. Computer server 132 may be generally controlled and coordinated by an operating system software. The operating system controls allocation of system resources and performs tasks such as processing, scheduling, memory management, networking and I/O services, among other things. Thus, the operating system resident in system memory and executed by CPU coordinates the operation of the other elements of the system 100.

Although the description of the application server 140 may refer to terms commonly used in describing particular computer servers, the description and concepts equally apply to other processing systems, including systems having architectures dissimilar to that shown in FIG. 1.

The system 100 may also include the image server 130 or a plurality of image servers that manage(s) digital photographs and other human viewable images. The image server 130 may be configured separately from the application server 140. This configuration may increase the scalability of the server system 100. Alternatively, the application server 140 and the image server 130 can be configured together. Examples of image formats that can be managed by the image server 130 include, but are not limited to, Graphical Interchange Format (“GIF”), Joint Photographics Experts Group (“JPEG”), or Portable Network Graphics (“PNG”) or Tagged Image File (“TIF”).

The mail server 160 is a repository for e-mail messages received from the Internet 102. It also manages the transmission of electronic messages (“electronic mail” or “e-mail”). The mail server 160 consists of a storage area, a set of user definable rules, a list of users and a series of communication modules.

The databases 120, 122 store software, descriptive data, digital images, system data and any other data item required by the other components of the system. The databases may be provided, for example, as a database management system (DBMS), and object-oriented database management system (ODBMS), a relational database management system (e.g. DB2, ACCESS etc.), a file system or another conventional database package. Thus, the databases 120, 122 can be implemented using object-oriented technology or via text files. Further, the databases 120, 122 can be accessed via a Structured Query Language (SQL) or other tools known to one of ordinary skill in the art.

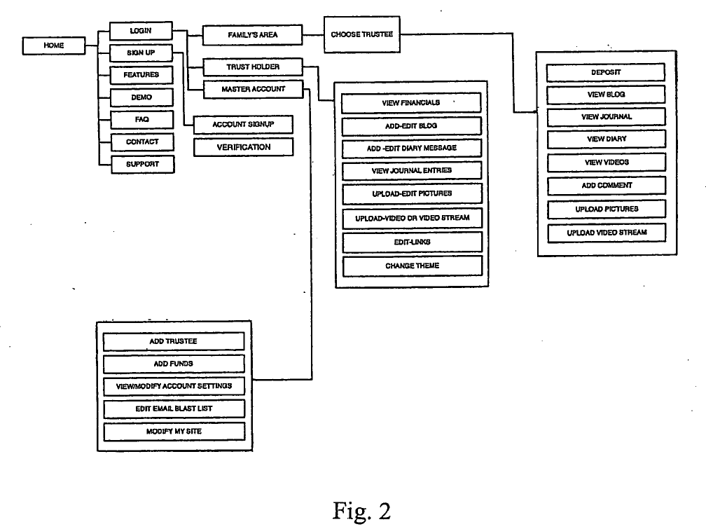

FIG. 2 is a page flow diagram showing how the system allows the user to deposit money at the trust fund account and to post journals, pictures, videos, and other information relevant to the trust fund account, when necessary. A trustor or other authorized person may create this home page for a trust fund. The entry point into the system is a web site, if an Internet configuration is selected. However, the system could be connected directly to the internal computer network of the institution, either on-site or via dedicated communication lines. A user can enter a system through a login screen. Each user must enter a User ID and a password to “log in” to the system. In addition to providing security for the database, the User ID/password is used by the system 100 to control access to particular documents or sets of documents, as well as to restrict access to the administrative functions. Upon successful log in, the user is provided with a customized home page. The signup process must collect basic personal information, including the information necessary to authorize access to the trust fund account, and a password, which will be used to create a user account for the trust fund account. A logout button will serve to completely log the user out of the system, close the system and destroy all cached information so that no information stored can be accessed in the system after logout has occurred.

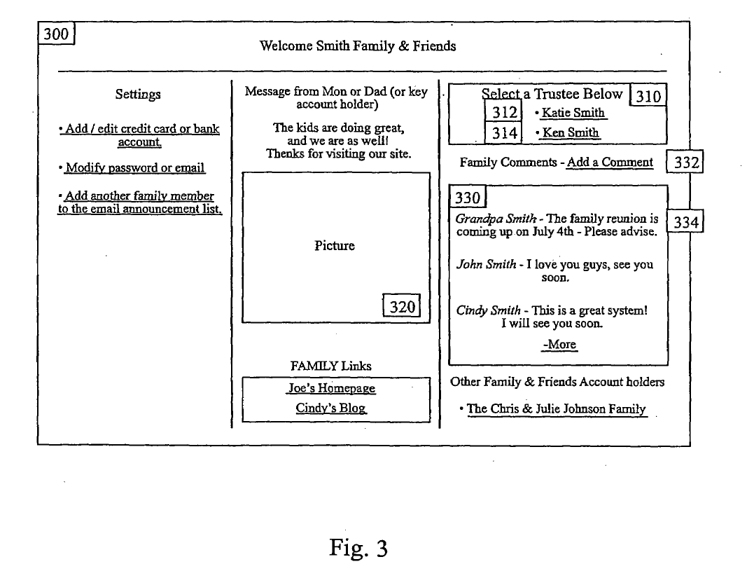

Once inside the system, the user can then be presented with a plurality of program frame items. The home page can provide links to various web pages, depending on the user's level of authority. From the home page, the user can proceed to a different functional area of the system by clicking one of several link buttons or menu options. FIG. 3 shows an exemplary graphical user interface that may be displayed in embodiments of the present invention when a user clicks on an icon for the family's area. The home page links to a family area 300. The family area 300 is the main entry for family members and friends that have been granted access to enter this family area 300. The family area 300 provides a link to enter a selected beneficiary's area 310. For example, the trustor, the parent in this embodiment, can create the beneficiaries' account areas 312, 314 respectively for his daughter, Katie Smith, and his son, Ken Smith. The users can be linked to the daughter's account area by clicking on the menu option 312. The trust holder or other users who have authority can post pictures 320 on the family area 300 to decorate the family area 300. The family area 300 allows the users to post any information, such as family news or announcements of family events, in a family comments area 330 as well as links to other web sites, if desired. The family area 300 provides links 332 to add a comment to the family comments area 330. The family comments will be verified and approved by the key account holder. For example, message 334 is addressed to the family area 300. In one embodiment, some messages can be addressed only to a specific group of the users. Similarly, messages may be addressed to “All” users, or may comprise a universal message. Each message may include a menu bar providing options for manipulating the message. Options may allow a user to print a message to a printer device, delete a message from the display area, mark a message as read, mail a message to some other system, edit a message and read extended messages. Within Add a Comment, the user can enter basic text or draw comments with a keyboard or a stylus and choose which users could access the message. The user can also attach rich content to the message and add annotations. Other options may be provided in alternative embodiments of the present invention. Moreover, the menu of options need not be provided individually on each message. That is, a single menu may be used to manipulate selected messages. Alternatively, other user interface options may be implemented to present the menu of options to a user (e.g., “right-clicking” on a message may result in a menu being displayed).

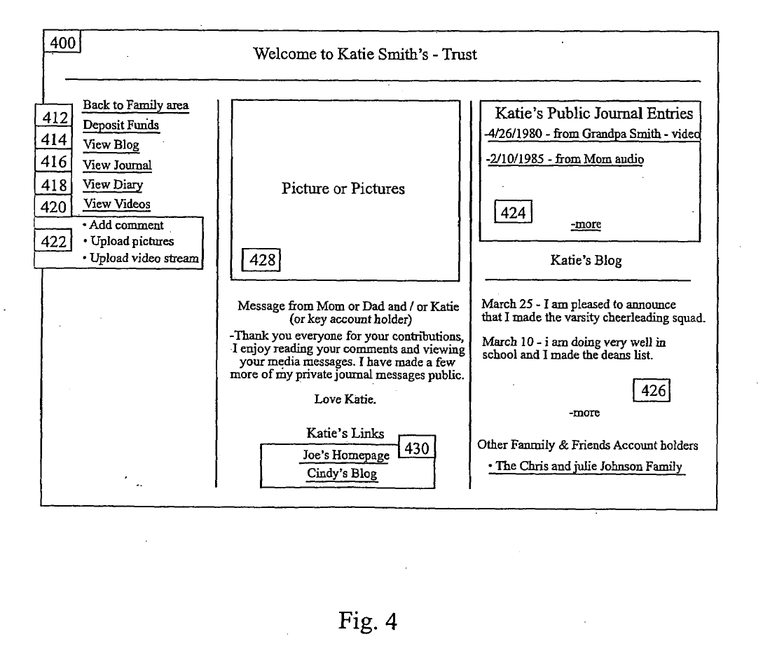

From the family area 300, the user can proceed to a beneficiary's public area 400 by clicking the menu option 312 for the daughter's account. FIG. 4 shows an exemplary graphical user interface that may be displayed in embodiments of the present invention when a user clicks on an icon for the beneficiary's public area 400. In one embodiment, the beneficiary's public area is the public area for the family members and friends to communicate and view messages from the beneficiary and the trustee.

The beneficiary's public area 400 provides the user with an option 412 to deposit or transfer funds into the beneficiary's trust fund account. Numerous other systems associated with such money deposit or transfer over the network will be readily apparent to those of ordinary skill in the art. The beneficiary's public area 400 can also provide an option 414 to view the beneficiary's blog (a short form of “weblog”) or link to his/her own homepage. The blog is a user-generated website where entries are made in journal style. In a further embodiment, the beneficiary's public area 400 displays recent updates 426 in the beneficiary's blog. The beneficiary's public area 400 further provides an option 416, 420 to view the beneficiary's journal entries and videos. These journal entries are entered or uploaded by family and friends while these videos can be uploaded by the beneficiary or other users. The beneficiary's public area 400 provides an option 418 to view diary which has been written by the beneficiary. Option 422 may allow authorized users to add and/or edit a message from the display area and to upload pictures, video or audio files to the beneficiary's journal. A preferred link option 430 may provide the authorized users with a direct link to other homepages of beneficiary, family member or friends. The authorized users may be allowed to edit the preferred links list. Other options may be provided in alternative embodiments of the present invention.

In one embodiment, if the beneficiary sets up the beneficiary's journal or the blog to be displayed to the authorized users, the beneficiary's public area 400 displays the beneficiary's journal 424 or the blog 426. In a further embodiment, if the beneficiary sets up his or her personal messages, pictures, video or audio entries to be displayed to the authorized users, the beneficiary's public area 400 displays the messages, pictures, video or audio entries 428.

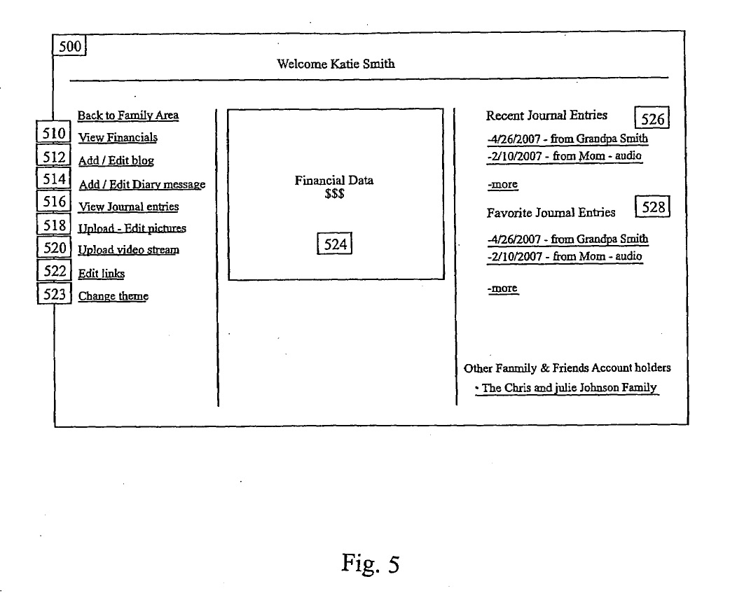

From the home page, the user can proceed to a beneficiary's private area 500 by clicking one of several link buttons or menu options. FIG. 5 shows an exemplary graphical user interface that may be displayed in embodiments of the present invention when a user clicks on the icon for the beneficiary's private area 500. The beneficiary's private area 500 is the page which displays the financial data for the beneficiary's trust fund account. Further, the beneficiary's private area 500 allows the beneficiary to edit his or her public area 400. Since the beneficiary generally has administrative privileges (for which information is recorded in the user record and assessed by the system when the user logs in), the beneficiary can access the beneficiary's private area 500. However, it can be another user's private area, such as a private area for the trustee or trustor. In that case, only a person who has administrative privileges can access the private area to modify the public area 400. For example, the beneficiary's private area 500 links to a financial section 510 of the beneficiary's trust fund account. The system 100 can provide an online statement of the beneficiary's trust fund account. However, there is no persistent view of the online statement, as such. The online banking module, not shown, is essentially a staging area where the user views transactions before using them to reconcile their checkbook or money transfer. When the beneficiary views his or her online statement, the data and amount of deposit/payment is available for his information. In a further embodiment, the beneficiary's private area 500 can display the basic financial data 524 of the beneficiary's trust fund account, such as total cash to date, interest earned, and projections.

In one embodiment, the beneficiary can edit their blog or diary, using the respective menus 512, 514. The edited blog and the diary can be displayed to the authorized users on the beneficiary's public area 400. The beneficiary or other authorized users can view journals entered by family members or friends using an option “View journal entries” 516. The beneficiary can upload/edit pictures/video files using the options 518, 520. The uploaded pictures and video files can be displayed to the authorized users on the beneficiary's public area 400. Numerous other systems associated with such online bulletin boards which can upload and edit messages, image files, and/or motion picture files will be readily apparent to those of ordinary skill in the art. The authorized users can also edit the menu options or displayed links using the menu options for “Edit Links” 522. To change the beneficiary's public or private area theme, the background patterns and/or icons may be recalled by the beneficiary or other authorized users using an option “Change theme” 523.

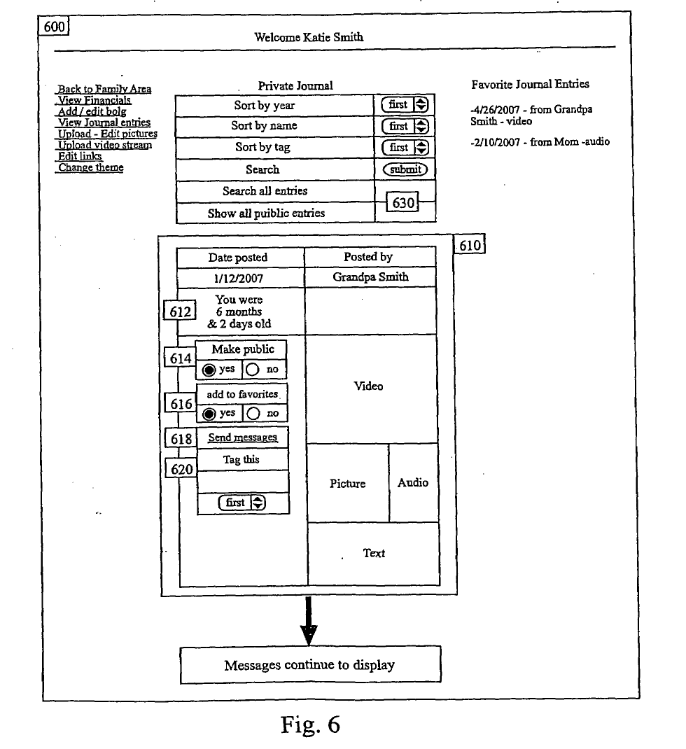

In one embodiment, the beneficiary's private area 500 displays a short description or titles of recent journal entries 526 entered by the users. The underlined links will go to the content of the journal entries. The beneficiary's private area 500 can display short descriptions or titles of the journal entries selected as “Favorite Journal Entries” 528. The beneficiary may have the option to choose which entries are their favorite entries and the beneficiary's private area 500 displays the short description of the selected journal entries. FIG. 6 shows an exemplary graphical user interface that may be displayed in embodiments of the present invention when a user clicks on an icon for the beneficiary's private journal area 600. The option 516 can link to the beneficiary's private journal area 600. In this area 600, the beneficiary will see the most recent entries at the top of the list. The journal messages can consist of text, video, audio or pictures. One screen 610 shown in this example displays profile data for the posted journal messages. It displays the age of the beneficiary 612 when the message was posted. The interface 610 also allows the beneficiary to make the message public. When this toggle 614 is selected as YES the message is now added to the beneficiary's public journal 700. The interface 610 also allows the beneficiary to add the message into the beneficiary's favorite entries section 616. Further, the beneficiary may have options to send a link that displays the messages to a desired e-mail address or list of e-mail addresses 618. The beneficiary can tag a selected message with a keyword, which facilitates a sorting process. The beneficiary's private journal area 600 includes an interface 630 for sorting the posted messages. The interface 630 allows the beneficiary to sort the posted messages by year, name of posters, tag (keyword) or content. The interface 630 also has links to show all entries and show public entries. In a further embodiment, a search button can allow the user to search messages for keywords or a plurality of words appearing in the message subject or message body.

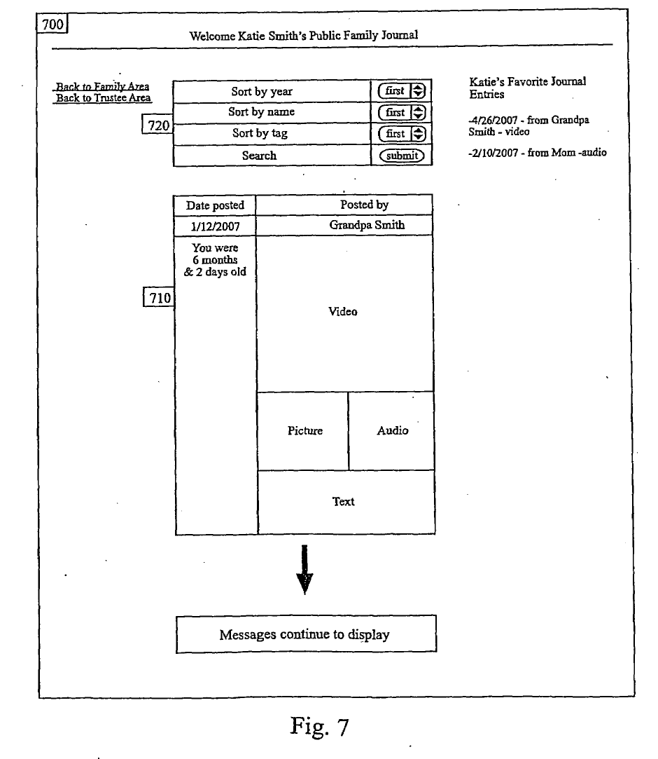

FIG. 7 shows an exemplary graphical user interface that may be displayed in embodiments of the present invention when a user clicks on an icon for the beneficiary's public journal area 700. The beneficiary's public journal area 700 comprises a message board 710 and the sorting interface 720. The message board 710 displays messages selected by the beneficiary to be made public as well as the beneficiary's chosen favorite entries. The message board 710 displays text, video, audio or pictures, depending on the format of the posted message. The sorting interface 720 allows the authorized users to sort the posted messages by year, name of posters, tag (keyword) and/or content.

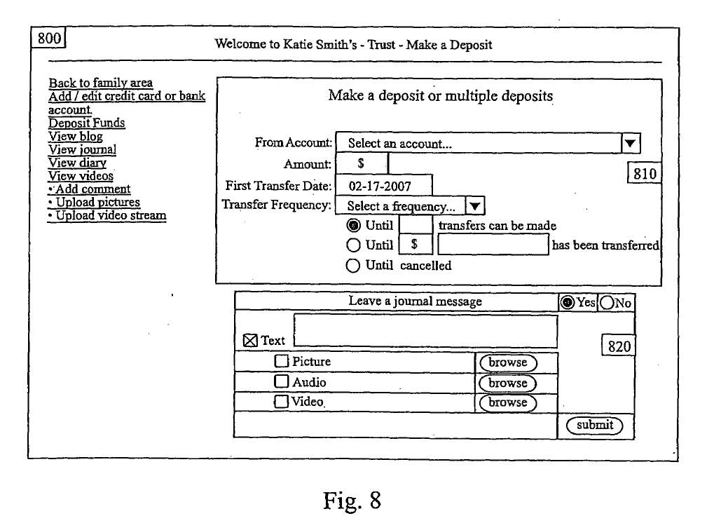

FIG. 8 shows an exemplary graphical user interface that may be displayed in embodiments of the present invention. At the outset it is felt best to describe some of the principles employed in implementing the flexible interactive service including an embodiment of the invention. For simplicity and clarity of exposition, these principles will be presented in the context of an interactive banking service. Only users authenticated for using this online trust fund account can access to this account. Once authenticated, the authorized user can make a deposit either by direct deposit or transfer. The online account interface 800 comprises the deposit interface 810 and a message editor 820. The deposit interface 810 prompts the authorized user to select a source and target account, and a transfer amount, and performs the transfer if the customer has enough money in the source account, and transfers are permitted between the two accounts. The deposit interface 810 permits one time money transfer or executes standing orders for periodic transfers to be made. The depositor can set up an amount, a transfer date and a frequency of the periodic transfers using the deposit interface 810. The depositor can also enter a message in association with his or her deposit, using the message editor 820. The message can contain one or more of the following text, pictures, video, and audio format data. The message editor 820 allows the user to enter or upload the message.

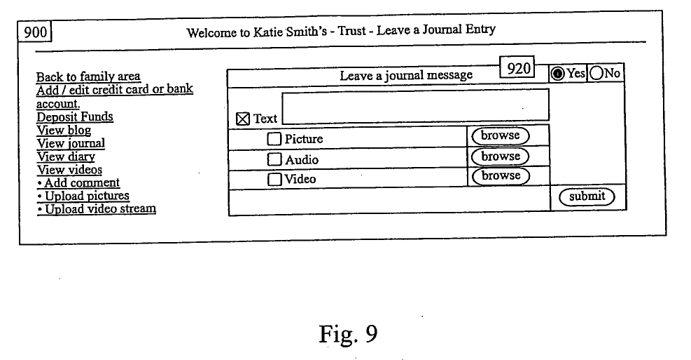

FIG. 9 shows an exemplary graphical user interface 900 that may be displayed in embodiments of the present invention. The depositor can also enter a message in association without his or her deposit, using the message editor 920. The message can contain one or more of the following text, pictures, video, and audio format data. The message editor 920 allows the user to enter or upload the message.

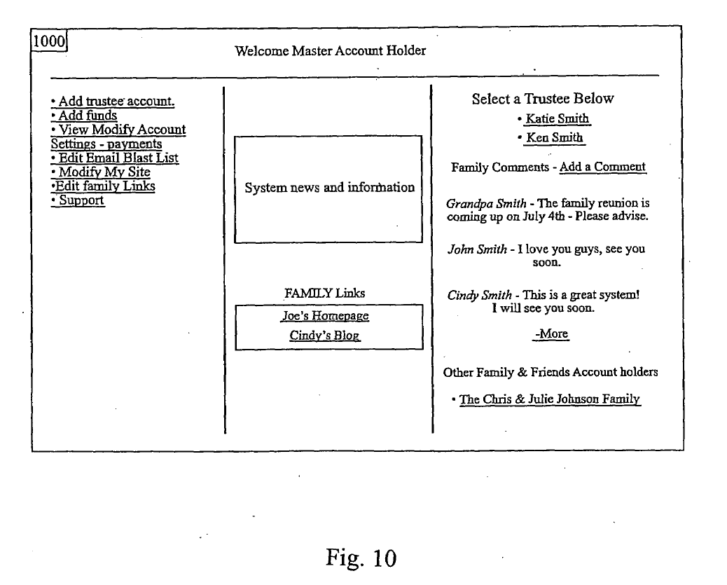

FIG. 10 shows an exemplary graphical user interface that may be displayed in embodiments of the present invention when a user clicks on icon for the master account area 1000. Trustor, parent, or legal guardian, who has created this online homepage, can be an administrator who has authority to control the homepage using the master account area 1000. The master account area 1000 offers site administration functionality, trust-wide reporting functionality, and document approval functionality. The administrator can control users' categorizations which determine the scope of the access permitted to each of the web pages. They can also determine which messages are to be hidden from certain users. This information is determined when a user first enters the system and/or when some change occurs, such as a promotion or transfer. The administrator is also responsible for message approval. Site administration functions therefore provide a means to define the organizing structures of the document data and user data, consisting of attributes, categories, sections and linking rules. It also provides a means to control the content of the home page. For example, if the administrator is a trustor, the administrator can add a beneficiary, add funds for the child, and/or modify account settings. Further, the administrator can add and edit the e-mail blast list of family and friends. The administrator may modify the graphical configuration of the family portal web page and modify the family links in the family area 300.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

The terminology used in the description of the invention herein is for the purpose of describing particular embodiments only and is not intended to be limiting of the invention. As used in the description of the embodiments of the invention and the appended claims, the singular forms “a”, “an” and “the” are intended to include the plural forms as well, unless the context clearly indicates otherwise.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that relative terms are intended to encompass different orientations of the device in addition to the orientation depicted in the Figures.

Moreover, it will be understood that although the terms first and second are used herein to describe various features, elements, regions, layers and/or sections, these features, elements, regions, layers and/or sections should not be limited by these terms. These terms are only used to distinguish one feature, element, region, layer or section from another feature, element, region, layer or section. Thus, a first feature, element, region, layer or section discussed below could be termed a second feature, element, region, layer or section, and similarly, a second without departing from the teachings of the present invention.

It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Further, as used herein the term “plurality” refers to at least two elements. Additionally, like numbers refer to like elements throughout.

Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow. The scope of the disclosure is not intended to be limited to the embodiments shown herein, but is to be accorded the full scope consistent with the claims, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims.

What is claimed is:

1. A computer implemented method for managing a financial account, the method comprising:
establishing the financial account having a donor and an account holder;
establishing a plurality of user accounts for accessing a management tool via a computer network;
wherein at least one of the use accounts is a donor user account and the donor user account is provided with permissions to place money and/or property in the financial account for the benefit of the account holder; and
wherein at least one of the user accounts is an account holder user account and the account holder user account is provided with access to a journal to post one or more of text, video, and audio that may be made accessible to one or more other users.

2. The computer implemented method for managing a financial account of claim 1, wherein the financial account is a trust account.

3. The computer implemented method for managing a financial account of claim 1, further comprising:
providing online banking tools to the account holder whereby the account holder may access account information including balances, deposits, and withdrawals.

4. The computer implemented method for managing a financial account of claim 1, further comprising:
establishing one or more user accounts for users other than donors that may be provided access to content provided by the account holder.

5. The computer implemented method for managing a financial account of claim 1, wherein the management tool is accessible via the Internet.

6. The computer implemented method for managing a financial account of claim 1, wherein users other than the account holder may add content that may be accessed by other users, the content comprising one or more of text, video, and audio files.

7. The computer implemented method for managing a financial account of claim 6, wherein each user account is associated with a customizable home page.

8. A computer implemented system for managing a financial account over a computer network, the system comprising:
a client device
a router;
an application server that is accessible by the client device via the router;
a database for storing trust account information;
wherein a plurality of users may access the application server and database from a client device to manage the financial account, and the system is configured to be accessible by at least one account holder and at least one account manager.

9. The computer implemented system for managing a financial account over a computer network of claim 8, wherein the system may also be accessed by at least one donor, and the donor may deposit money or property into the trust account.

10. The computer implemented system for managing a financial account over a computer network of claim 8, wherein one or more of the users may add content that may be accessed by other users, the content comprising one or more of text, video, and audio files.

10. The computer implemented system for managing a financial account over a computer network of claim 7, wherein online banking tools are provided to the account holder whereby the account holder may access account information including balances, deposits, and withdrawals.

11. The computer implemented system for managing a financial account over a computer network of claim 7, wherein the financial account is a trust account.
